(19) United States
(12) Patent Application Publication
(10) Pub. No.: US 2007/0054170 A1
(43) Pub. Date: Mar. 8, 2007

(54) Oxygen ion conductors for electrochemical cells

(76) Inventor: Arnold O. Isenberg, Pittsburgh, PA (US)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/217,697

(22) Filed: Sep. 2, 2005

(51) Int. Cl. H01M 8/12; H01M 4/90

(52) U.S. Cl. 429/33; 429/45

(57) ABSTRACT

In solid oxygen ion conducting electrolytes for electrochemical cells based on magnesium oxide and calcium oxide, obtained by the addition of metal fluorides selected from elements in the groups of alkali metals and earth alkali metals to the host oxides of magnesium and calcium, conductivity values are obtained, which are comparable with those of stabilized zirconia, but the magnesium oxide and calcium oxide based oxygen ion conducting electrolytes have a superior thermodynamic stability and, therefore, can operate at much lower oxygen concentrations in comparison with other oxygen ion conducting electrolytes and without becoming noticeably electronically conductive.

### BACKGROUND OF THE INVENTION

1. Field of the Invention

The present invention relates to the field of electrically conductive solid oxides, where the movement of oxygen ions is the major cause for the conduction of electric charges through the bulk oxide. When an electric field is applied to a pair of electrodes, which are in contact with such oxides, electric charges are transported within the oxide by the movement of oxygen ions, accompanied by a mass trans port of oxygen through the oxide. Such conducting oxides are commonly referred to as solid electrolytes. The conductivity of solid electrolytes is influenced greatly by the chemical composition of oxides, and is a strong function of the temperature.

Solid electrolytes are used for sensors to measure oxygen concentrations of solids, liquids, and gases, whereby a first attached electrode is exposed to a known oxygen concentration, and a second electrode, separated from the first electrode by the solid electrolyte, is exposed to an unknown oxygen concentration. The differing oxygen concentrations at the two electrodes establish an electrical potential gradient, which is measured as a direct current DC-voltage. The measured voltage is related to the oxygen concentration differential, which, for purely ionic conduction of the solid electrolyte, is expressed by the Nernst equation.
E=RT/n F×In pO_{2(high)}/pO_{2(low)} (1)

In equation (1) E designates the electromotive force in volts, R is the universal gas constant, T is the absolute temperature, n equals 4, the number of electrons transferred to a molecule of oxygen, and F represents the Faraday constant; the natural logarithm of the oxygen concentrations quotient of the two electrodes is expressed by the second factor in equation (1), wherein either electrode can be used as the known reference entity. The described electrodes/electrolyte combination is known as an electrochemical concentration cell.

Solid electrolytes, as described here, are mixtures of metal oxides with additions of other elements in order to reduce their electrical resistance. Also, these added elements serve in stabilizing the crystal structure of the electrolyte, modifying their chemical properties, as well as their thermal expansion behavior. The practical temperature range for the application of oxygen ion conducting electrolyte devices lies between 300° C. to above 1000° C. For instance, oxygen sensors cover a wide range of applications for oxygen concentration measurements, which apply to gases, liquid metals, liquid salts, and solids, whereby the temperature of the different media is high enough so as to render the solid electrolyte of the sensor sufficiently conductive and the electrodes sufficiently active, in order to measure stable voltages. Combustion control is an important application for oxygen sensors to achieve optimal power generation and for automotive emission control. Oxygen sensors applied in metallurgical processes serve as means to control oxidation or reduction processes, as well as metal heating, and in the ceramic industry, in addition to combustion control, one can achieve desired color tones of fired ceramic bodies by precise oxygen control of the kiln atmosphere. The present invention widens the field of oxygen sensor application to more extreme condition environs, which cannot be analyzed by known solid electrolyte-based sensors.

In another application one can use the generated DC voltage of the described electrochemical concentration cell to generate electrical power by maintaining a high oxygen concentration at one electrode, for instance, by a flow of air, while maintaining a very low oxygen concentration on the other electrode, for instance, by a flow of hydrogen or carbon monoxide gases. When the electrodes of such a concentration cell are connected to an electrical device, such as motor or resistor, constant electrical work can be performed as long as the gas flows are maintained. In this application oxygen is consumed at one electrode, called the air electrode (cathode), and is transported as oxygen ions through the solid electrolyte to the other electrode, called the fuel electrode (anode). At the fuel electrode the oxygen ions transfer electrons to the external circuit and the oxygen oxidizes the fuel to water vapor and or carbon dioxide. The described device is called a solid oxide fuel cell (SOFC).

In a closely related application the operation of an SOFC is reversed by the connection of a DC power supply to the electrodes, such a cell arrangement is called an electrolysis cell. In this fashion water vapor and carbon dioxide can be electrochemically decomposed into oxygen and hydrogen or carbon monoxide. A constant replenishment of water vapor and or carbon dioxide to one electrode is provided to generate a constant flow of hydrogen and carbon monoxide and flow of oxygen from the separated compartment of the other electrode.

The use of electrolysis cells is of great interest and is being developed for earth-bound as well as near-space applications, such as oxygen recovery for space habitats, fuel and oxygen generation for Mars return missions. Solar cell power supplies would provide the needed electrical energy for electrolysis and the Mars-atmosphere and Mars-ice provide the chemical feed stocks. Similar, but less complex applications are being considered and investigated for future industrial processes that use clean solar energy to provide the chemical feed stocks oxygen, hydrogen, and carbon monoxide, necessary for a host of organic synthetic materials for daily use. Oxygen gas can be removed from gas mixtures via oxygen ion conducting solid electrolyte cells, which, in function, are similar to electrolysis cells. A successful application of this process is of great interest to producers of inert gases of high purity.

Solid electrolytes are used as resistors for resistance heating in electrical kilns, however, by using alternating current (AC) power sources. In mixtures with electronically conducting oxides and metals they are used as composite electrodes for applications in SOFCs, electrolysis cells, and sensors.

2. Description of the Prior Art

One of the earliest detailed studies of oxygen-ion conducting solid electrolytes is that of E. Baur and H. Preis, published in Ztschr. Physical. Chem. B21, 25 (1933) as applied to fuel cells. This study includes, among others, doped zirconium oxide and cerium oxide as solid electrolytes, including an oxide mixture of 85% zirconium oxide and 15% of yttrium oxide (Nernst mass). Sintered rods of this oxide mixture had been used in early electrical incandescent lamps as light emitting resistors. The mixed oxide had also been identified as an oxygen ion conductor. Today, commonly used oxygen-ion conducting solid electrolytes are based also on zirconium oxide or zirconia (ZrO₂). The pure zirconia is made an ionic conductor by minor additions (doping), of other oxides such as calcia (CaO), yttria (Y₂O₃), scandia (Sc₂O₃), and other oxides of the group of rare earth elements in the periodic table of elements. The solid-state solutions of the oxide additions in zirconia cause a change in the crystal structure, namely, from the tetragonal one to the stabilized face-centered cubic one. One calls these doped oxide mixtures stabilized zirconia. Yttria-stabilized zirconia (YSZ) is the best-known and widest used solid electrolyte while scandia-stabilized zirconia (SSZ) has the highest conductivity. Zirconia stabilization can be achieved by high temperature sintering of compacted mixtures of finely milled oxide powders. During the heat treatment a solid-state diffusion process causes some of the 4-valent zirconium cations to be replaced by 3-valent yttrium and scandium cations or by the 2-valent calcium cations. The demand for electro-neutrality within the crystal lattice makes the formation of oxygen ion vacancies necessary. These vacancies allow oxygen ions to freely and randomly change positions within the crystal lattice when their oscillations become increasingly larger with increasing temperature. In this fashion the mixed oxide becomes an oxygen ion conductor at elevated temperature. Crystal lattice imperfections, therefore, are the cause for oxygen ion mobility in the single crystal structure. Another cause for oxygen ion mobility is the extreme crystal lattice deformation and irregularities at crystal-grain boundaries, and all practical solid oxide electrolytes consist of bodies of densely packed grains. Grain boundaries, therefore, afford other passages for oxygen ions however grain boundary ion diffusion is a minor contribution to electrical conduction as compared to diffusion through the bulk of the crystal grain via oxygen ion vacancies.

Other oxygen-ion conducting solid electrolytes can be based on ceria (CeO₂), thoria (ThO₂), uranium oxide (UO₂), bismuth oxide (Bi₂O₃), and lanthanum gallate (LaGaO₃) as the host oxides. In mixtures and solutions with a variety of other oxides, which create oxygen ion vacancies in the respective host oxides, they can be used in solid-state electrochemical concentration cells such as oxygen sensors, fuel cells, and electrolysis cells. Many other oxides such as magnesia (MgO), alumina (Al₂O₃), and silica (SiO₂) have been investigated in scientific studies as solid electrolytes with respect to their conduction mechanism, and as functions of temperature and oxygen concentration. A fundamental study of oxides as solid electrolytes in concentration cells was published by H. Schmalzried in the Zeitschrift fuer Physikalische Chemie Neue Folge, vol. 38, p87-102 (1963), wherein basic oxide properties of solid electrolytes, such as electronic and ionic charge carriers and their effect on electromotive forces, E, are investigated. In another study by S. P. Mitoff in The Journal of Chemical Physics, Vol. 31, No. 5, November 1959, single crystals of MgO are investigated with respect to its electrical conduction mechanism. Both studies lead to the conclusion that magnesium oxide is not suited as solid oxygen ion conducting electrolyte for practical devices.

U.S. Pat. No. 4,019,974. (H. Weyl, L. Steinke) teaches an important solid electrolyte-based oxygen sensor structure that is widely used in automotive combustion/emission control. Solid electrolyte oxygen sensors are mostly constructed in tubular electrolyte shape to better accommodate heat shock, however flat electrolyte plates can also be used. In practical sensor devices, a relatively thick solid electrolyte layer provides also the mechanical support for electrodes and their contacts, as well as surface shapes for sealing; a modest increase of electrolyte resistance due to increased thickness does not affect good voltage measurements.

In another application of an YSZ electrolyte device, U.S. Pat. No. Re. 28,792 (Ruka et al.) teaches a cell in tubular form. The YSZ tube is coated inside and outside with platinum electrodes. At an elevated temperature and in air one can apply a DC power supply to the electrodes and electrochemically separate oxygen from air and produce a pure stream of oxygen and nitrogen at the respective electrodes. Oxygen evolves at the electrode attached to the positive terminal of the DC power supply. In this current carrying cell, which is basically equivalent to an electrolysis cell, YSZ-electrolyte is used because it is a much better oxygen ion conductor than calcia-stabilized zirconia. Oxygen removal from inert gases is a field of interest for gas producers, since present processes include the chemical gettering of oxygen with reactive metals, such as highly reactive porous titanium, whereby titanium is oxidized at elevated temperatures and needs to be replaced periodically. A solid electrolyte electrolysis cell operating as an oxygen pump would be a superior process for purifying inert gases such as nitrogen (N₂), helium (He), neon (Ne), argon (Ar), krypton (Kr), and xenon (Xe) because it offers an uninterrupted process with potential cost savings.

The use of solid electrolytes for electric power generation is taught in U.S. Pat. No. 4,490,444 (A. O. Isenberg). This patent teaches a SOFC cell structure with a very thin layer of YSZ electrolyte, in order to minimize electrical resistance losses. U.S. Pat. No. 5,492,777 (A. O. Isenberg, R. J. Ruka) teaches an electrochemical energy conversion and storage system that combines the cell function of an SOFC structure with the mode of operation equivalent to an electrolysis cell, inorder to store electrical energy. This type of oxygen ion conducting electrolyte cell is, in essence, equivalent to a secondary battery for the storage of electrical energy, and this device makes use of very thin YSZ electrolyte layers also, in order to minimize energy losses, in the form of heat, during operation.

Solid oxide electrolyte oxygen sensors are used in metal melts such as copper and steel to measure the oxygen content of the melt for controlling de-oxidation and degree of carburization respectively. Such applications impose severe conditions upon the heat shock sensitive ceramic solid electrolytes and with respect to chemical attack by metals, slag or other contaminants. In such severe cases of application one often uses disposable sensors, which feature fully- or partially-incorporated oxygen reference electrodes within the electrolyte body, which are attached to feed-through insulated contact wires. U.S. Pat. No. 3,915,830 (A. O. Isenberg) teaches an oxygen sensor with a fully incorporated oxygen reference electrode within a solid oxygen ion conducting electrolyte cell structure. Oxygen reference electrodes are made, preferably, with intimate mixtures of metals with their own oxides, for instance, equilibrium mixtures of nickel/nickel oxide (Ni/NiO), copper/copper oxide (Cu/Cu₂O), palladium/palladium oxide (Pd/PdO), and chromium/chromium oxide (Cr/Cr₂O₃). The oxygen concentration reference values of these mixtures decrease in order of the metals Pd, Cu, Ni, Cr, they provide very accurate oxygen reference potentials as long as the sensor temperature is known. The total loss of sensors in severe application can present an expense problem since often noble metal thermocouples, incorporated in the sensors, are consumed and the loss of the electrolyte presents an additional expense because the most useful rare earth element oxides, such as yttrium oxide, ytterbium oxide, and scandium oxide, are expensive. Lower cost disposable sensors that can measure very low oxygen activities in metal processing would be desirable.

While the mentioned solid oxygen ion conducting electrolytes, including their cell geometries, modes of operation and applications, are very useful and varied, there exists a need for more advanced solid electrolytes that can be applied to the measurement of extremely low oxygen concentration (activity) levels, or for removal (addition) of oxygen from solids, liquids, or gases with DC-powered electrochemical cells. Presently known solid electrolyte materials are not capable to fulfill such functions for reasons, which are related to the thermodynamic stability of the solid electrolyte host oxide. For instance, when an YSZ based sensor is exposed to very low oxygen concentrations, the YSZ becomes a partial electronic conductor in addition to the ionic conduction. As a consequence, the measured cell voltage E is not useful for calculating the respective oxygen concentration using equation (1) because the two sensor electrodes are shorted by the introduction of an unknown and variable internal electronic resistor, which would reduce the measured voltage. A reduced cell voltage, however, would indicate a higher oxygen concentration in the measured medium (high oxygen concentration reference electrode). The onset of electronic conduction in solid oxygen ion conducting electrolytes, therefore, is a major hurdle in the use of the electrolytes for sensor or current devices, not only for YSZ but even more so for all other known practical electrolytes, which have an even lower thermodynamic stability than YSZ. Electronic conduction in a current-mode cell device would also lead to internally shorted oxygen diffusion that is opposed to the desired direction of oxygen ion- and oxygen gas-flow. Also, electrode-electrolyte interactions (formation of alloys and inter-metallic compounds) at low oxygen concentrations lead to false voltage readings. In most instances one can observe darkening or blackening of the electrolyte, which is a sure sign of induced electronic conduction and poor sensor or current-device function. The blackening of the solid electrolytes is often referred to as electrolyte “reduction”, which is not to be confused with the reduction of the oxide to metal but it is a step toward this real reduction and must be explained.

The free energy of formation of an electrolyte host oxide, for instance ZrO₂, is thermodynamically given by the value of ΔG_{T}, and which can be expressed as a function of the voltage E at which ZrO₂ would be reduced (theoretically) to metal in an electrochemical cell.
ΔG_{T}=−n F E (2)

In equation (2), ΔG_{T} is the free energy of formation in kcal at the absolute temperature T, and E is the electromotive force in volts, as in equation (1), n=4, the number of electrons of a molecule of oxygen, and F is the Faraday constant. The combination of equations (1) and (2) lead to the relationships between ΔG_{T}, as well as the corresponding E, to the oxygen concentration at which the oxide would be reduced to metal. The n-type electronic conduction in blackened electrolytes is caused by the extraction of neutral oxygen [O] from the crystal lattice, leaving oxygen ion vacancies with “free” electrons, these entities are called “color centers” and they cause the darkening of the electrolyte. The free electrons cause the undesirable electronic conduction. Since oxygen extraction from the oxide crystal lattice is a step toward the threshold of real oxide reduction to metal, as determined by the ΔG_{T} value of the oxide, this value is an important parameter for the choice of a host oxide for an oxygen ion conducting solid electrolyte.

Since all common metal oxides are well known and thoroughly investigated one must assume that the present state of technology for oxygen ion conducting solid electrolytes is exhausted and not suited for applications in extremely low oxygen activity environs as they exist in modern metallurgy for metals such as, aluminum, titanium, zirconium and their alloys with other metals. The purification of inert or noble gases from oxygen, which play an important role in modern metallurgy and in the manufacturing of electronic components, cannot be achieved satisfactorily with known types of electrochemical solid oxide electrolyte cells.

### SUMMARY OF THE INVENTION

It is the object of the present invention to provide oxygen ion conducting solid electrolytes that advance solid electrolyte electrochemical cell applications to fields, where present technology is inadequate. This is achieved by the use of a new class of oxygen ionic conductors, based on the host oxides magnesium oxide (MgO) and calcium oxide (CaO). MgO, has been investigated as solid electrolyte in its pure form and at very high temperatures, it has a very high resistance and exhibits mixed electronic conduction and, therefore, is not useful as a practical solid electrolyte. However, MgO in a mixture with a minor amount of magnesium fluoride (MgF₂) exhibits significant oxygen ion conduction at a much lower temperature than the pure oxide and electronic conduction is not observed in electrochemical cells using the mixture as a solid electrolyte. Similarly, CaO is referred to in the scientific literature also as a mixed conductor at high temperatures and is, like MgO, not useful as electrolyte in its pure form. However, CaO in a mixture with a minor amount of calcium fluoride (CaF₂) exhibits significant oxygen ionic conduction, without noticeable electronic conduction, as measured by current- and voltage-mode electrochemical cells.

These surprising findings were expanded through the formulation of other Oxide—Fluoride—Mixtures, all of which are referred to in the following as OFM. The other metal fluoride additions to CaO and MgO that were investigated are lithium fluoride (LiF) and sodium fluoride (NaF). The surprising result was that the alkali fluoride additions to the host oxides led to even higher levels of oxygen ion conduction, as measured in electrochemical cells with OFM electrolytes operating in the current- and voltage-mode.

It has been stated above that the value of the free energy of formation, ΔG_{T}, of an oxide plays an important role in the selection of potential host oxides for electrochemical cells that are to be applied in extremely low oxygen activity environs, whether as voltage- or current-mode devices. In this respect both, CaO and MgO, are thermodynamically more stable than ZrO₂ and other host oxides. Also the metal fluoride components in the OFM materials, in thermodynamic terms, are some of the most stable compounds known to men.

An x-ray diffraction analysis was performed on MgF₂-doped MgO in order to determine the unit cell dimension of the doped MgO crystal lattice. It was found, that the unit cell dimensions were identical with that of pure MgO, however, a second phase of pure MgF₂ was present. The analysis indicates that no fluorine anions were incorporated into the interstices of the MgO crystal lattice and, therefore, did not cause the formation of oxygen ion vacancies in the bulk crystal lattice, which, had it occurred, would have significantly increased the unit cell dimension of the doped MgO. This surprising fact leads to the conclusion that the oxygen ion conduction of this OFM material is not through the bulk crystal structure but via vacancies along grain boundaries. The mechanism of oxygen ion conduction is of secondary consequence for the application of OFM materials as oxygen ion conducting electrolytes in electrochemical cells operating in the voltage mode only, however, it is of consequence for the manufacturing of it, because in this case, optimal ionic conduction is more a function of grain size (grain surface area) than of the amount of MgF₂ addition. For bulk electrical conduction, for instance in YSZ, the amount of additive is of greater importance than grain boundary diffusion of oxygen ions.

In the case of LiF-doped MgO, and NaF-doped CaO, an x-ray diffraction analysis indicates some diffusion of lithium and sodium into the bulk of the respective crystal lattices of the oxides, which explains the considerably higher conductivity of the respective OFM materials, because of the formation of additional oxygen vacancies by the introduction of 1-valent elements into a 2-valent element host oxide.

As far as OFM electrolytes are concerned, it is concluded that grain boundary conduction is a significant and sufficient oxygen ion conduction mechanism for the application of OFM oxygen ion conducting electrochemical cell devises in extremely low oxygen activity environs. Bulk oxygen ion conduction, as mentioned in the case of LiF- and NaF-doping of MgO and CaO respectively, can exist in other OFM electrolytes, which enhances their wider application as current-mode devices. An important aspect in the application OFM electrolyte devices is their very low cost with respect to raw materials of construction.

The significant findings underlying this invention lead to applications of OFM electrolyte devices in 3 device categories, namely, 1. OFM electrolyte cells operating in the current mode for primary and secondary batteries, fuel cells, and electrolysis cells, and, 2. OFM electrolyte cells operating in the voltage mode for high to very low oxygen activities, and, 3. OFM electrolyte compositions used for resistance elements in electrical heaters.

In device category 1., primary and secondary batteries can be built using highly reactive metals as anode materials, like the alkali elements lithium (Li), potassium (K), sodium (Na);

earth alkali elements like magnesium (Mg), calcium (Ca), and strontium (Sr); other elements like zink (Zn), aluminum (Al), cerium (Ce), titanium (Ti), zirconium (Zr), silicon (Si), manganese (Mn), Iron (Fe), cobalt (Co), and nickel (Ni), and carbon (C). These elements alone or as alloys or inter-metallic compounds with one or more of these elements, can provide useful anodes. These anode compositions can be mixed with OFM electrolyte to better the electrochemical anode oxidation.

Cathodes for primary cells and secondary cells can be at least one of the group of platinum, palladium, iridium gold, silver, copper, nickel, cobalt, iron, as well as, oxides of praseodymium (Pr₆O₁₁), palladium (PdO), copper (Cu₂O, CuO), iron (FeO, Fe₂O₃, Fe₃O₄), nickel (NiO), cobalt (CoO), zinc (ZnO), indium (In₂O₃), bismuth (Bi₂O₃, BiO), antimony (Sb₂O₃, SbO₂), and tin (SnO, SnO₂) and mixtures of two or more of these metal oxides. These anode compositions can be mixed with OFM electrolyte to better the electrochemical cathode reduction. Also gaseous oxygen can be considered as the cathode reactant in combination with electronically conducting porous electrodes that are attached to the OFM electrolyte.

Solid OFM electrolyte fuel cells can be constructed by using the multiple existing cell geometries, electrodes, and other cell and generator materials, which are familiar to experts in the SOFC technology. Since long-term exposure to water vapor increases OFM electrolyte resistance, one can protect it with layers of other oxygen ion conductors or choose hydrogen-free fuels, such as carbon monoxide. A CaO-based OFM electrolyte fuel cell was tested, using nitrogen-diluted H₂/H₂O fuel mixtures. The measured cell voltages at various temperatures were comparable with those measured in parallel with that of an YSZ electrolyte fuel cell. This test cell result is an independent proof that the OFM electrolyte is an oxygen ionic conductor as well as the suitability of the OFM electrolyte for concentration cells in oxygen sensors.

OFM electrolyte electrolysis cells can be built using multiple designs, using, preferably, tubular, as well as, planar cell construction. Such cells can be applied for the removal of oxygen from inert gases and noble gases to extremely low levels, that is, nearly four orders of magnitude lower than what can be achieved, theoretically, with YSZ electrolyte cells. This is due to the significantly greater thermodynamic stability of MgO and CaO versus that of ZrO₂ (difference of ΔG_{1000K} values: −18 kcal per gram-mol for MgO, −38 kcal per gram-mol for CaO) and the associated lower equilibrium oxygen concentration as calculated by using equations (1) and (2). An oxygen concentration, equivalent to 2.15 volt (versus oxygen as reference), has been measured with an MgO-based OFM oxygen ion conducting electrolyte cell, according to equation (1) this value corresponds to an oxygen concentration of 9.04×10⁻³³ atmosphere. The OFM electrolyte, used in this test measurement, did not show any discoloration after the test, indicating that the measurement was not affected adversely by obvious electronic conduction. This measurement is discussed further below. Independent measurements on YSZ electrolytes with platinum electrodes show an onset of electronic conduction (blackening) already at a potential of 1.5 volt or 5.86×10⁻²³ atmosphere of oxygen. Such low, calculated, concentrations of oxygen are never achieved in practical devices for the bulk gas streams, they exist only directly at the electrode/electrolyte contact points, however, the relative values indicate the considerable advantage of MgO—, and CaO-based OFM electrolyte current-mode cell over a similar one employing an YSZ electrolyte for oxygen removal from gases.

The high degree of oxygen removal from gases such as nitrogen (N₂), helium (He), neon (Ne), argon (Ar), krypton (Kr), and xenon (Xe), can best be achieved with OFM oxygen ion conducting electrolyte cells operating in the current-mode.

The OFM electrolyte cells can be equipped with electrodes, cathodes as well as anodes, made from metals such as copper (Cu), silver (Ag), gold (Au), and from metals of the group-VIII elements in the periodic table of elements, namely, iron (Fe), cobalt (Co), nickel (Ni), ruthenium (Ru), rhodium (Rh), palladium (Pd), osmium (Os), iridium (Ir), and platinum (Pt). Other useful electrode metals include chromium (Cr), manganese (Mn), molybdenum (Mo), tungsten (W), as well as silicon (Si), and carbon (C); these elements, pure or as alloys or intermetallic compounds with one or more of the mentioned metals, can be used with OFM electrolyte devices. The addition of OFM electrolyte to these, preferably porous, metallic electrodes is useful to improve electrode kinetics and catalytic behavior, also additions of pure or mixed solid oxides of these elements to the porous metal matrix of such electrodes, exclusive of molten or vapor phase oxides, have similar benefit for improving electrode performance.

Other electrode materials for OFM oxygen ion conducting electrolyte cells include electronically conducting oxides such as doped indium oxide (In₂O₃), doped tin oxide (SnO₂) and complex oxides of a larger group called perovskites having the general chemical formula ABO₃. In this formula A represents at least one element from the group consisting of calcium, strontium, barium, yttrium, scandium, lanthanum, cerium, praseodymium, neodymium, samarium, gadolinium, and ytterbium. B of the formula represents at least one element from the group consisting of manganese, iron, cobalt, nickel, copper, zinc, magnesium, aluminum, gallium, indium chromium, titanium, zirconium, hafnium, vanadium, niobium, and tantalum. Other electronically conducting oxides include complex oxide, based on earth alkaline elements and lanthanide elements with titanium dioxide (TiO₂). The addition of OFM electrolyte to the porous electrode structure of these complex electronically conducting oxides leads to improved electrode performance.

In device category 2., most OFM electrolyte cells are operated in the voltage mode of electrochemical concentration cells, as used in many oxygen sensors. The physical make-up of sensors with OFM electrolyte can be made nearly identical to existing sensor designs, however, new designs will be required for OFM electrolyte sensors that find use under new and severe conditions and processes. OFM electrolyte structures for sensors include tubular shapes, with one or both ends open, being heated to sensor operating temperature by external means or by internal heaters. Disk-shaped OFM electrolytes for sensors can be used with compression-seals, ceramic-, glass-, and metal seals, they are heated by external means or by heaters which are placed near the electrolyte. The type and materials of electrodes for OFM electrolyte sensors are made from identical electronic conductors as detailed for current-mode OFM electrolyte cells.

Oxygen reference electrodes can be attached to or incorporated in the OFM electrolyte material. Reference electrode materials must provide a stable oxygen concentration and stable capacity of oxygen for long-term operation. This requirement is fulfilled by using metal/metal oxide reference electrodes, in the form of powder packs, compressed pellets or similar and used as such. Adding OFM electrolyte material to reference electrode compositions improves electrode stability and response time. Reference electrodes made of metal/metal oxide mixtures are members of the group consisting of Ru/RuO₂, Rh/RhO, Pd/PdO, Os/OSO₂, Cu/Cu₂O, Co/CoO, Ni/NiO, and Cr/Cr₂O₃. Metal/metal oxide electrodes can be contacted electrically with wires of the respective metal in the electrode and with metals of a more noble character. Typical contact wire metals for electrodes, therefore, are palladium, platinum, gold, and silver they can also be used to contact metal/metal oxide reference electrodes.

The sensing electrode of an oxygen sensor, which is separated from the reference electrode by the OFM electrolyte and by adequate seals, can be made as porous layers of palladium, platinum, gold, silver, copper, nickel, cobalt, iron, molybdenum, tungsten, and carbon, using these materials also as electrical contact means to the electrodes in the form of wires, rods, or other structural sensor members. The function of sensing electrodes can be improved by the incorporation of OFM electrolyte material into the porous electrode structure.

OFM oxygen ion conducting electrolytes can also be used as structural combination with other solid oxygen ion conducting electrolytes. For instance, OFM electrolyte can be coated one-sided or two-sided with YSZ layers or vice versa to form composite electrolyte structures. Composite electrolyte structures are used to adjust the solid electrolyte combinations to specific physical and chemical needs as imposed by an increasing variety of applications for oxygen sensors or other cell structures using solid oxygen ion conducting electrolytes. Equivalent composite solid oxygen ion conductor electrolytes, made of OFM electrolytes in combination with solid electrolytes based on UO₂, CeO₂, Bi₂O₃, and LnGaO₃, can be used.

An important OFM based oxygen sensor application has been identified for the aluminum processing technology. The metal aluminum is produced by the electrolysis of aluminum oxide (Al₂O₃) dissolved in a molten cryolite (Na₃AlF₆) electrolyte bath. The electrodes in this bath are made from various forms of carbon, and the electrolysis cells operate at a temperature level near 900° C. The dissolved aluminum oxide concentration must be carefully controlled in order to minimize the negative impact of the so called “anode effect”. This anode effect penalizes this major industrial process with increased electric energy cost, as well as, through the formation of carbon tetra fluoride (CF₄), an environmentally hazardous gas (ozone depletion), at the anode. The near complete consumption of dissolved aluminum oxide in the cryolite melt is the cause for the anode effect. The very low oxygen concentration in the electrolyte bath varies with the concentration of the dissolved aluminum oxide and this low oxygen concentration can be measured with oxygen sensors, which are based on OFM oxygen ion conducting electrolyte cells. A sufficiently accurate measurement of the oxygen activity in the cryolite melt can be used to determine the point at which fresh aluminum oxide must be added to the melt and thus avoid the anode effect and CF₄ formation. The cryolite melt is chemically very aggressive and attacks most known oxides, including OFM compositions, however, in the form of disposable OFM electrolyte cell-elements of low cost one can afford to place multiple sensors in various bath positions. YSZ electrolyte sensors cannot be used in this application because of the electronic conduction, which is induced in the YSZ material due to the extremely low oxygen concentration, as has been discussed above. OFM electrolyte based sensors can also be used for measuring oxygen concentrations of other dissolved metal oxides in cryolite melts, used for metal winning, and is not restricted to the electrolysis process for aluminum.

The oxygen concentration measurement in cryolite melt was done at 1000° C. using a MgF₂ doped MgO electrolyte cell, which was mounted in a graphite holder. The OFM electrolyte of the cell was in intimate contact with an attached Cr/Cr₂O₃ reference electrode and a sensing electrode made of graphite, which was in contact with the cryolite melt that contained dissolved aluminum oxide. Measured voltages were as high as 2.14 volt at 1000° C., a value that was mentioned above. The measured value compares well with a calculated electrolysis voltage for Al₂O₃ of 2.20 volt.

When sensors, based on OFM electrolyte concentration cell design, are used for measuring the oxygen concentration in molten ferrous or non-ferrous metals, such as steel or copper, the application of a sensing electrode to the OFM electrolyte is superfluous since the molten metal provides the electrode itself. In molten metal application a high heat shock tolerance of an oxygen sensor is of great importance during the melt immersion process. Since all oxygen ion conducting solid electrolytes are of a ceramic nature, having brittle-fracture characteristics, replaceable sensor electrolyte members of low cost are desirable. OFM electrolyte, especially MgO-based OFM material, exhibits significantly higher heat shock tolerance and significantly lower cost than yttria-stabilized zirconia (YSZ) electrolyte.

Device category 3 includes the use of OFM electrolyte materials for the fabrication of electrical resistors, for instance, in the form of heating elements for furnaces and in combination with AC-electrical power supplies. The practical application limit of such heating elements is determined by reactive gas atmosphere conditions and loss of metal fluoride content from the OFM electrolyte by vaporization at very high temperatures.

OFM oxygen ion conducting electrolytes as discussed in the three categories of application can be made from the host oxides MgO and CaO individually or from mixtures thereof in any ratio. CaO has a higher thermodynamic stability than MgO, and therefore can be used in all discussed applications also, even at lower oxygen activities than MgO. CaO based OFM electrolytes are sensitive to a combination of humidity and carbon dioxide (CO₂) at room temperature and must be appropriately protected from deterioration by dry or hot storage. Mixed MgO/CaO host oxide based OFM electrolytes exhibit increased stability in moist air.

Metal fluoride additions to host oxides are employed in a concentration range of 0.1 mol % to 40 mol % of the OFM composition. This composition range is based on the fact that grain boundary oxygen ion diffusion can be achieved with a very low concentration of precipitated fluorides at grain boundaries of the host oxide, and that an excessive amounts of fluorides, exceeding 40 mol % cause undesirable mechanical and electrical properties of the resulting materials.

The group of metal fluoride additives in OFM electrolytes are: LiF, NaF, KF, MgF₂, CaF₂, and SrF₂. Metal fluorides, consisting of at least one from the group of metal fluoride additives, when added to the host oxide MgO, form MgO-based OFM oxygen ion conducting electrolytes having the above stated concentration limits. Metal fluorides, consisting of at least one from the group of metal fluoride additives, when added to the host oxide CaO, form CaO-based OFM oxygen ion conducting electrolytes having the above stated concentration limits. Furthermore, metal fluorides, consisting of at least one of the group of metal fluoride additives, when added to multiple-ratio MgO/CaO host oxide compositions, form MgO/CaO-based OFM oxygen ion conducting electrolytes having the above stated concentration limits.

The OFM oxygen ion conducting electrolyte materials can be prepared by a variety of standard ceramic processes and techniques, such as multiple calcining/milling operations to homogenize OFM compositions followed by a compacting and sinter process for the various electrolyte shapes, like tubes (open both ends, one end closed), and plates (planar, complex shapes). OFM oxygen ion conducting electrolyte cell shapes can be formed by the methods of slip casting, isostatic pressing, die pressing, and extrusion.

The sintering operation is conducted in a manner that prevents an excessive loss of fluoride additive through high temperature vaporization of metal fluorides. This can be achieved by placing the sinter product in metal containments such as foils of platinum, iridium, tungsten, molybdenum, carbon, iron, cobalt, nickel, and chromium. Cover gases for sintering include at least one in the group of hydrogen, nitrogen, helium, neon, argon, carbon dioxide, and oxygen. Preferred cover gas compositions are nitrogen or argon, each with a minor content of hydrogen (1-5 vol. %). A very useful sintering process is isostatic hot pressing. This process can produce maximum OFM density at the lowest sinter temperature and can reduce the loss of fluoride additives during the sinter process. Since grain boundary oxygen ion conduction is important for some OFM electrolyte compositions it is important to achieve minimal grain size of host oxides and maximal sinter rates in order to maximize grain boundary oxygen ion conduction.

OFM electrolyte layers can be obtained by physical vapor deposition, such as sputtering, and by thermal spray processes, such as laser ablation, flame spraying and plasma spraying. Layered composite electrolyte structures, which are made of OFM oxygen ion conducting electrolyte with other oxygen ion conducting electrolytes, such as YSZ and others can be produced by the mentioned physical and thermal deposition processes. Also, sintered electrolyte layers, whether OFM-based or other, can be surface-coated by physical vapor deposition or thermal spray processes with various other solid electrolytes for the fabrication of composite electrolytes.

Electrodes can be applied to OFM electrolyte devices by well known methods, such as painting, screen printing, spraying, and transfer methods for metallic electrodes and oxide electrodes, followed by thermal burn-in or sintering methods. In addition, electrodes can be applied by physical vapor deposition, such as, electron beam evaporation, and sputtering methods. Thermal spray processes, such as plasma spraying, flame spraying, and laser ablation, can also be used to apply electrodes to OFM electrolyte structures.

The discovery of the new class of OFM oxygen ion conducting electrolytes creates new device opportunities in the fields of primary and secondary high temperature batteries, solid electrolyte fuel cells, electrolysis cells, electrochemical oxygen pumps for gas purification, oxygen sensors for combustion processes, such as for internal combustion engines, electric power generation and heating, and in metallurgical processes related to metal smelting, metal heating, and metal winning.

The invention will become more readily apparent from the following descriptions of diagrams and of preferred embodiments of the invention, by way of example only, with reference to the accompanying drawings.

### BRIEF DESCRIPTIONS OF THE DRAWINGS

FIG. 1 is a diagram showing the specific conductance of a selected number of OFM electrolyte materials in air, and as a function of the inversed absolute temperature T,

FIG. 2 is a schematic cross-section representation of an OFM electrolyte disk in contact with two different metal/metal oxide electrodes for potential and current measurements,

FIG. 3 is a voltage-current characteristic of an OFM electrolyte concentration cell for proof of reversibility,

FIG. 4 is a schematic cross-section representation of an OFM electrolyte in tubular form as supplied with an outer sensing electrode and an internal metal/metal oxide reference electrode,

FIG. 5 is a schematic cross-section representation of a tubular OFM electrolyte oxygen pump assembly for oxygen transport from one gas to another gas,

FIG. 6 is a schematic cross-section representation of a tubular OFM electrolyte electrolysis cell assembly for oxygen recovery from carbon dioxide,

FIG. 7 is a schematic cross-section representation of an oxygen sensor structure, having a replaceable OFM electrolyte cell member, with attached metal/metal oxide reference electrode, for oxygen activity measurements in cryolite melts,

FIG. 8 is a schematic cross-section representation of an OFM electrolyte member for an oxygen sensor having an enclosed metal/metal oxide reference electrode, and

FIG. 9 is a schematic representation of an OFM electrolyte heating element/electrical contact arrangement.

### DESCRIPTION OF THE PREFERRED EMBODIMENTS

The following descriptive explanation is best accomplished by examples of OFM electrolyte compositions, how they are prepared, applied in cell structures, and used for electrochemical measurements.

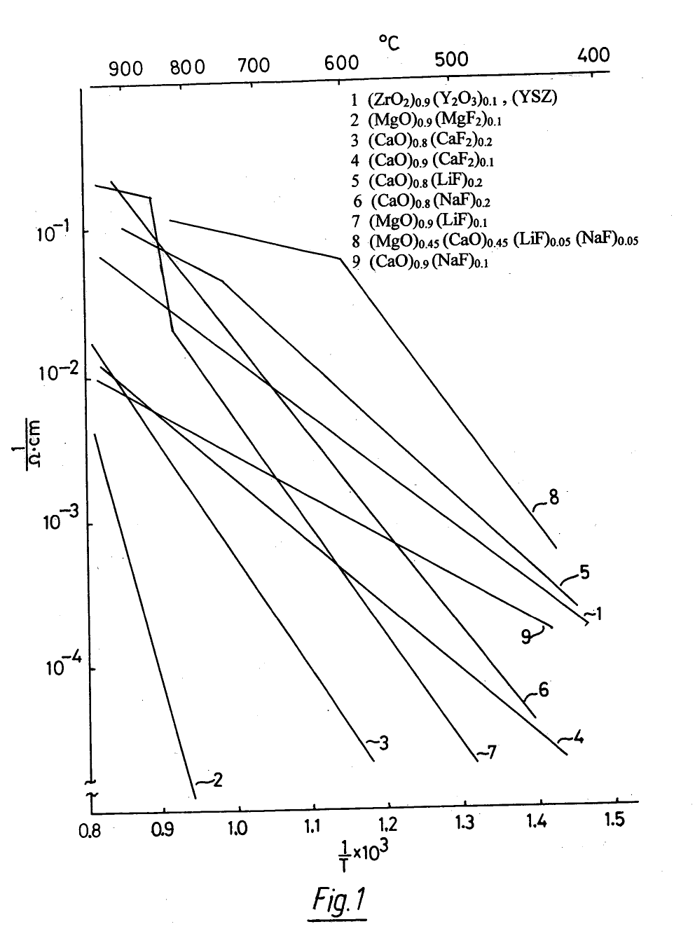

FIG. 1 shows the conduction behavior, measured in air, of several representatives of OFM electrolyte materials as a function of the inverse absolute temperature T, as an example only of a much larger number of useful OFM electrolyte materials. The diagram shows that LiF-, and NaF-additions, as high as 20 mol %, to CaO-based OFM electrolytes, line 5 and 6 respectively, result in conductors that can be compared at elevated temperatures to YSZ electrolyte, line 1. The diagram shows also, that MgF₂ doped MgO, line 2, and CaF₂ doped CaO, lines 3 and 4, conduct less than YSZ by a factor of approximately five to ten, respectively, near 1000 ° C. The addition of LiF to MgO, line 7, significantly increases the conductivity over that of MgF₂-doped MgO, line 2, as a result of additional bulk oxygen ion vacancies in MgO due to lithium diffusion into it. Line 8 is the OFM characteristic of a mixed host oxide, MgO/CaO, doped with LiF and NaF. The breaks in characteristic slopes, line 7 and 8, at higher temperatures are explained as the points at which melting of the alkaline metal fluoride phase becomes noticeable. All OFM oxygen ion conducting electrolytes so composed, are described here as the “group of OFM oxygen ion conducting electrolytes”.

Host oxides and their additives have been processed into OFM electrolyte bodies as follows: The dried powders were weighed and intimately mixed in a mortar, after which they were compacted in a steel die to disks of 0.75″ diameter and 5-10 mm in thickness. The pressed disks were enclosed in nickel foil, placed in an electric tube furnace for homogenization (calcination) in a nitrogen/7% hydrogen cover gas atmosphere, and were heated to near 1350° C. for approximately one hour. The homogenized OFM compositions were crushed to a fine granular size and then ball milled in acetone, using zirconia-ball milling media, to a grain size of 5 μm or less. The operations of compaction were repeated with smaller powder portions. Powder compacts were sintered in nickel envelopes under identical cover gas flow and at/or below a maximum temperature of 1440° C. for a maximum duration of two hours. The maximum sintering temperature of 1440° C. for OFM the electrolyte compositions, was selected as a safe limit with respect to the melting point of the nickel containment (1455 ° C.). The resulting OFM electrolyte disks were of a thickness between 0.5 mm and 2.0 mm. Sintered disks were inspected for degree of porosity and were processed further for testing. Most OFM electrolyte test specimens for AC conduction measurements, as shown in FIG. 1, were processed as described above with the exception of the OFM electrolyte disk sample, represented by line 9, which was sintered between platinum foils in a cover gas atmosphere of air at 1470° C.

For electrical cell tests of OFM electrolytes, which required sealing between electrode gas spaces, the disks were polished to provide flat sealing surfaces. Electrodes of platinum, gold, and silver were applied by painting and burn-in operations. Metal/metal oxide electrodes were applied as compacted and pressed powder layers and in direct contact with the OFM electrolyte.

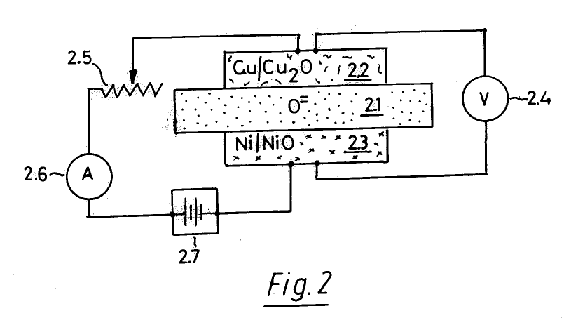

The thickness of OFM oxygen ion conducting electrolyte layers in electrochemical cells is largely determined by their application with respect to lowering electrical cell resistance; it lays in a practical range of 1 μm to 5 mm, however, it is not restricted to this range In FIG. 2 an OFM electrolyte planar cell arrangement, of the type that has been tested, is shown in schematic cross-section, wherein the electrolyte disk 2.1 is contacted by two electrodes, 2.2 and 2.3, in the form of disks of compacted powder mixtures of metals with their respective oxides, which were spring-pressed onto the electrolyte. The entire cell assembly was pressed via an alumina rod, into a closed-end alumina tube (both not shown). The tube was purged with pure nitrogen to eliminate trapped oxygen from the CaO-based OFM electrolyte cell assembly. The electrodes were contacted with a pair of nickel wires at each electrode in a commonly known electrical test circuit for electrochemical cells, which includes a volt meter 2.4, a variable load resistor 2.5, a DC current meter 2.6, and a DC power supply 2.7. The Cu/Cu₂O electrode is the cathode (higher oxygen activity), and the Ni/NiO electrode is the anode (lower oxygen activity).

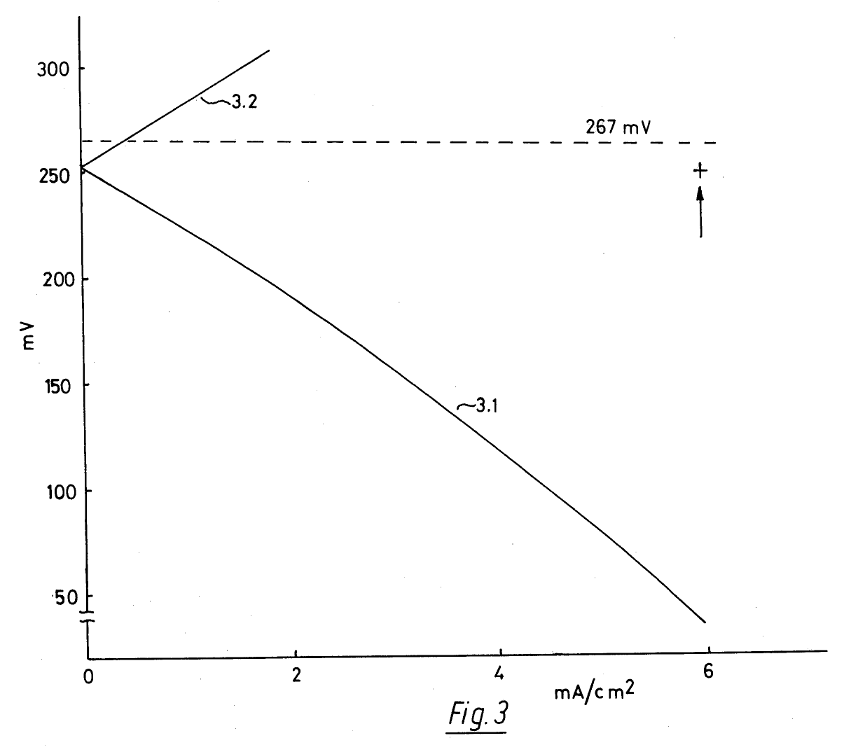

The electrochemical performance of this cell near 1000° C. is shown in FIG. 3, depicting a voltage-current (V-I) characteristic 3.1. The calculated open cell voltage of 267 mV (using the ΔG_{T} value difference of the oxides Cu₂O and NiO, in equation 2) compares favorably with the measured cell voltage of 255 mV, especially in view of the fact that the electrode compartments in this assembly were not hermetically sealed from each other. It is also of significance that this OFM electrolyte concentration cell exhibits a fast cell voltage response when switched from a near short-current load to open cell voltage, as indicated by the arrow at the current density level of 6 mA/cm² in FIG. 2. The discharge mode of this cell is equivalent, with respect to the OFM electrolyte function only, to a fuel cell, wherein the oxidant oxygen (from copper oxide) is applied to the cathode, and fuel (in the form of nickel), to the anode. Furthermore, it is significant that the direction of the current flow can be reversed, as done in the charging of a secondary electrochemical power cells, or in electrolysis cells, indicated by the near mirror images of a portion of the V-I characteristics 3.1 and 3.2. The OFM electrolyte concentration cell according to FIG. 2 established, for the first time, that the elected OFM electrolyte composition is an oxygen ion conductor, having no noticeable amount of electronic conduction. The OFM oxygen ion conducting electrolyte cell according to FIG. 2 establishes also the basic fact, that OFM electrolyte materials can be used as electrolytes in oxygen sensors, primary and secondary batteries, fuel cells, and electrolysis cells.

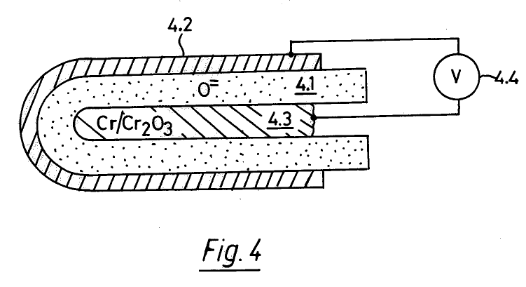

A preferred embodiment of a tubular OFM electrolyte structure for oxygen sensors is shown in cross-section and in schematic representation only in FIG. 4. The closed-end tubular OFM electrolyte 4.1 is coated on its outside with a sensing electrode 4.2. A reference metal/metal oxide electrode 4.3 made of a pressed-in powder mixture of chromium metal and chromium oxide (Cr/Cr₂O₃), is placed inside the tubular electrolyte, and both electrodes are contacted with wires leading to a volt meter 4.4. The arrangement represents the basic components of a practical oxygen sensor, exclusive of seals between electrode spaces and other structural members and mounting features of a variety of sensors, which can be used for combustion control of internal combustion engines, fossil fuel fired electrical power plants, as well as for combustion processes for general heating purposes or other. In the various sensor applications the reference electrode 4.3 can also be a gas reference electrode, for instance, using the stable oxygen concentration in air (20.9%) as a reference, whereby the metal/metal oxide electrode is replaced, preferably, with an air purged porous layer of platinum as electrode.

External as well as internal heaters (not shown) may be combined with sensor electrolyte members according to FIG. 4, to maintain sensors at an operational temperature level, for instance for the measurements of excess oxygen in lower temperature combustion (stack) gases, or to preheat sensors for fast response and for heat shock protection (internal combustion engines). It is easily seen that an open both ends tubular OMF electrolyte sensor members can be used as flow-through devices, whereby an oxygen reference gas stream, like air, is sealed from the sensed gas, for instance, for oxygen concentration measurements in slip streams of combustion processes.

The anode and cathode electrode materials for devices made of OFM oxygen ion conducting electrolytes are at least one of the elements copper, silver, gold, iron, cobalt, nickel, ruthenium, rhodium, palladium, osmium, iridium, platinum, chromium, manganese, molybdenum, tungsten, silicon, and carbon. These elements are referred to as the “group of metal electrodes”.

Electronically conducting oxides, preferably from the family of complex oxides called perovskites, of the general formula ABO₃ are also used as anode as well as cathode materials, wherein A designates at least one of the elements strontium, calcium and barium, yttrium, scandium, lanthanum, cerium, praseodymium, neodymium, samarium, gadolinium, and ytterbium, B designates at least one of the elements iron, cobalt, nickel, chromium, manganese, copper, magnesium, aluminum, gallium, indium, titanium, zirconium, hafnium, niobium, vanadium, tantalum, and zinc. The described oxide compositions applied as electrodes to members of the group of OFM oxygen ion conducting electrolytes, are referred to as “group of perovskite conductors”.

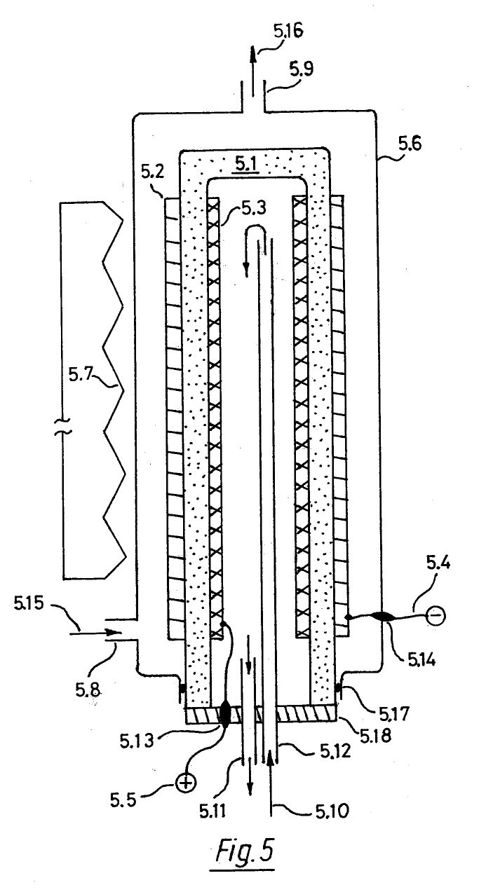

FIG. 5 shows, in cross-section and in a schematic representation only, an OFM electrolyte cell arrangement for the removal of oxygen and from a group of gases comprising nitrogen, helium, neon, argon, krypton, and xenon for purification. A closed-one end OFM electrolyte tube 5.1 is equipped with an external electrode 5.2 (cathode) and an internal electrode 5.3 (anode), both of which have been selected from the group of metal electrodes, the anode 5.3 may also be made from members of the group of perovskite conductors. The cell tube 5.1 can be purged on the inside by a gas flow 5.10 of nitrogen or argon entering the inlet 5.12 and exiting at outlet 5.11. The inside of the electrolyte cell tube is sealed by member 5.18 and the cell is placed with a gas seal 5.17 into a containment vessel 5.6 whereby only the cathode portion of the cell is enclosed by the vessel 5.6, which has a gas inlet 5.8 and an outlet 5.9. The vessel 5.6, including the OFM electrolyte cell, is heated to an operating temperature by heater means 5.7. Electrodes are contacted via conductors 5.4 and 5.5 via electrically insulated feed-through connectors 5.13 and 5.14; additional other similar electrode contacts (not shown) can be installed also. A voltage-controlled DC power supply (not shown) is connected to the anode 5.3 and cathode 5.2 via leads 5.5 and 5.4 respectively. An oxygen containing gas 5.15 enters vessel 5.6 at inlet 5.8 and leaves the vessel outlet 5.9 as a purified (oxygen free) gas stream 5.16. The applied cell voltage determines the degree of oxygen removal or gas purity.

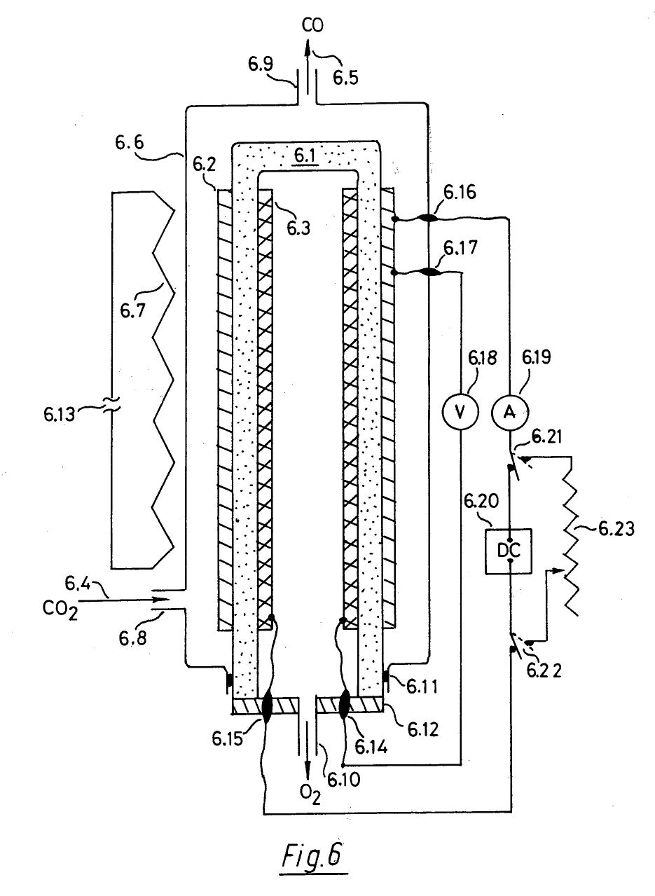

FIG. 6 shows, in cross-section and in a schematic representation only, an electrolysis cell arrangement. A closed end OFM electrolyte tube 6.1 is enclosed on its cathode, 6.2, side by vessel 6.6, having a gas inlet 6.8 and outlet 6.9. Vessel 6.6 is sealed to the OFM electrolyte tube by seal 6.11. The cell internal anode 6.3 is the site of oxygen gas evolution, oxygen exits at outlet 6.10, and the anode compartment of the electrolyte tube is sealed off by member 6.12. At the cathode 6.2 oxygen is extracted electrochemically, for instance from a flow of carbon dioxide 6.4, to decompose the gas into carbon monoxide and oxygen (at anode 6.3); the carbon monoxide flow 6.5 exits the vessel at the outlet 6.9. An AC power source 6.13 and heater means 6.7 bring the cell temperatures to an operational temperature level.

This cell arrangement is typical for electrolysis units, which operate with a DC power supply 6.20 input, and whereby the cell can be operated in a current control or voltage control mode. Cell electrodes are contacted by current and voltage leads, via insulated electrical feed-through means members 6.14 and 6.17 leading to a volt meter 6.18 and members 6.15 and 6.16 provide electrical feed-through means for the current, which is measured by a meter 6.19.

It is easily seen that an identical cell arrangement can be converted in function to a solid electrolyte fuel cell DC power source, by uncoupling of the DC power supply 6.20 via switches 6.21 and 6.22, and coupling to an electrical load circuit 6.23. In this operation, however, oxygen is consumed and must be provided continuously through orifice 6.10 to electrode 6.3, which is the cathode of the fuel cell. A flow of carbon monoxide fuel via orifice 6.9 over electrode 6.2, which is the anode of the fuel cell, is electrochemically combusted to carbon dioxide exiting orifice 6.8, thus generating DC electrical power. Cathode electrodes are made from members of the group of metal electrodes, and anode electrodes can be made from members of the group of metal electrodes, as well as from members from the group of perovskite conductors.

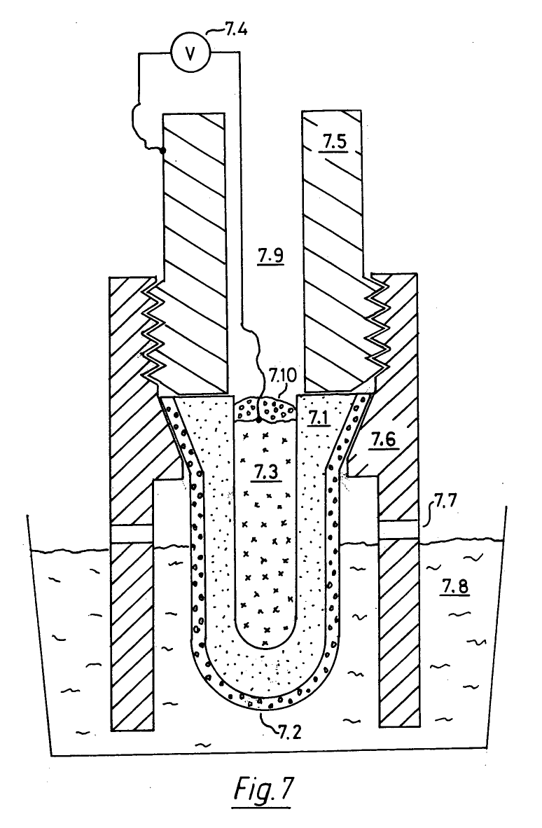

FIG. 7 shows, in cross-section and in a schematic representation only, a preferred embodiment of an OFM electrolyte-based oxygen sensor for measuring the oxygen concentration in a molten cryolite electrolyte bath. The sensor cell voltage is measured by means of a volt meter 7.4, which is electrically connected via metallic lead wires to the electrodes of the immerged sensor in the bath, whereby the measured voltage is directly related to the concentration of the dissolved aluminum oxide in the melt bath. The tubular OFM electrolyte member 7.1 of the sensor contains at the inside a chromium/chromium oxide reference electrode 7.3, and on the outside, preferably, a carbon based electrode 7.2 such as graphite. The OFM electrolyte body is shaped in a form that is suitable for ease of electrolyte replacement and separation from structural sensor members 7.5 and 7.6, which are made preferably from graphite or other form of carbon like glassy carbon. Suitable structural sensor members can be made also from boron nitride (BN) and silicon carbide (SiC). Because of varying electric (stray) fields within the cryolite electrolyte bath, the OFM electrolyte sensor element is electrically shielded by means of appropriate structural features of the electronically conducting member 7.6. The OFM electrolyte based oxygen sensor is immerged into the cryolite melt 7.8 and a controlled depth of immersion is obtained by orifices, such as 7.7 or similar. The electrical contact to the reference electrode 7.3 is made with electrically insulated wires of nickel, iron, nichrome, platinum, molybdenum, tungsten or other. Contact to the oxygen-sensing electrode 7.2 can be accomplished via the structural graphite members 7.5 and 7.6. During sensor immersion into the cryolite melt, the intrusion of oxygen gas from out-gassing sensor structures, which can affect measured alumina concentrations in the melt adversely, is avoided by purging the gas space 7.9 above the reference electrode with oxygen-free nitrogen or argon. Also, an electrically insulating ceramic sealant 7.10 minimizes oxygen influx to the metal/metal oxide reference electrode. The complete structural encapsulation of the reference electrode material in the OMF electrolyte can also ensure a stable oxygen reference potential. The sensor temperature is measured by a (reusable) thermocouple (not shown), located preferably in the sensor axial space 7.9, near to the OFM cell member.

Since the cryolite melt, with time, will chemically attack (by dissolution) the OFM electrolyte, one replaces the low-cost OFM electrolyte sensor member periodically. The frequency of replacement depends on the execution of the measurement (number of immersion cycles), sensing-electrode thickness, and time of exposure to the cryolite melt.

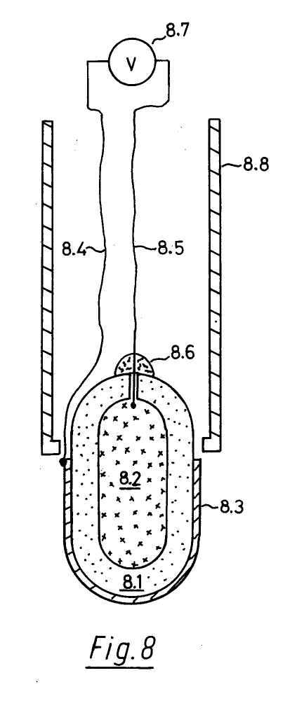

FIG. 8 shows in cross-section and in schematic representation only a cell structure for oxygen sensors consisting of an OFM electrolyte body 8.1 having an encapsulated metal/metal oxide reference electrode 8.2, which is electrically contacted with a metal wire lead 8.5, which extends through the OFM electrolyte enclosure. The contact wire to the reference electrode is electrically insulated against other sensor members and is sealed by member 8.6 at the point of exit from the OFM electrolyte enclosure; member 8.6 can be made of glass ceramics, various ceramic cements, boron nitride or similar. The sensing electrode 8.3 is contacted with an electrically insulated metal lead wire 8.4; lead wires 8.4 and 8.5 are connected to a voltmeter 8.7. The OFM electrolyte cell is structurally combined with sensor support member 8.8, and other required sensor members (not shown), such as thermocouple, shields, contacts, and housing members. This type of OFM electrolyte cell is particularly suited for replaceable oxygen sensor cell members, since the spatial and functional separation between the sensing electrode and the reference electrode is greatly simplified. Members of the group of metalmetal oxide electrodes as well as the contact lead wires to the reference electrodes can be incorporated in the OFM electrolyte by co-sintering.

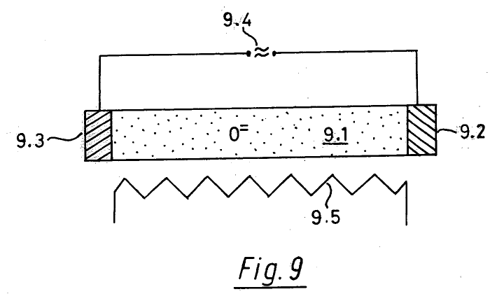

FIG. 9 shows, in schematic representation only, the embodiment of an electrical heater element 9. 1, made from OFM electrolyte compositions, with electrical heater power contacts 9.2 and 9.3, which are connected to an AC power supply 9.4. In order to function as a heater, the entire OFM electrolyte heater structure, including power contacts, must be preheated by appropriate pre-heat means 9.5, in order to render the OFM electrolyte heater element conductive enough for start-up operations. With increasing pre-heat temperature, the resistance of the OFM heating element is reduced and the heater becomes self-sustaining. Power contacts to the heating elements are made with electrode members from the group of metal electrodes, as well as with electronically conducting complex oxide members of the group of perovskite conductors.

What is claimed is:

1. Solid oxygen ion conducting electrolytes for electrochemical cells, which operate at elevated temperatures, said solid oxygen ion conducting electrolytes consisting of least one member of the group of host oxides, comprising calcium oxide (CaO), and magnesium oxide (NgO), wherein members of said group of host oxides are present in admixtures with at least one metal fluoride from the group consisting of lithium fluoride (LiF), sodium fluoride (NaF), potassium fluoride (KF), magnesium fluoride (MgF₂), calcium fluoride (CaF₂), and strontium fluoride (SrF₂), said mixtures of host oxides and said metal fluorides, being homogenized and sintered at high temperatures in containments and in a cover-gas atmosphere, thereby becoming solid oxygen ion conducting electrolytes, and including said host oxides in said solid oxygen ion conducting electrolytes in a concentration range of between 60.0 mol % and 99.9 mol %, and wherein the concentration range of said metal fluorides in said solid oxygen ion conducting electrolytes being in the range between 0.1 mol % and 40.0 mol %.

2. Solid oxygen ion conducting electrolytes for electrochemical cells, as recited in claim 1, wherein said mixtures of said host oxides with said metal fluorides are homogenized and sintered in said containments consisting of at least one of the group of platinum, iridium, palladium, iron, cobalt, nickel, carbon, chromium, molybdenum, and tungsten.

3. Solid oxygen ion conducting electrolytes for electrochemical cells, as recited in claim 1, wherein said cover-gas atmosphere, in which said mixtures of said host oxides with said metal fluorides additives are homogenized and sintered, consists of at least one of the group of hydrogen, nitrogen, helium, neon, argon, carbon dioxide, and oxygen.

4. Solid oxygen ion conducting electrolytes for electrochemical cells as recited in claim 1, wherein said oxygen ion conducting electrolytes are tubular bodies.

5. Solid oxygen ion conducting electrolytes for electrochemical cells, as recited in claim 1, wherein said oxygen ion conducting electrolytes are in the form of plates.

6. Solid oxygen ion conducting electrolytes for electrochemical cells, as recited in claim 1, wherein said solid oxygen ion conducting electrolytes have a thickness, ranging from 1 μm to 5 mm.

7. Solid oxygen ion conducting electrolytes for electrochemical cells, as recited in claim 1, wherein said electrochemical cells are sensors for measuring the oxygen concentration in molten cryolite baths.

8. Solid oxygen ion conducting electrolytes for electrochemical cells, as recited in claim 1, wherein said electrochemical cells are DC-current driven oxygen pumps for the removal of oxygen from gases such as nitrogen, helium, neon, argon, krypton, and xenon.

9. Solid oxygen ion conducting electrolytes for electrochemical cells, as recited in claim 1, wherein said electrochemical cells are DC-current driven electrolysis cells for the reduction of water vapor and carbon dioxide to hydrogen and carbon monoxide respectively, and oxygen.

10. Solid oxygen ion conducting electrolytes for electrochemical cells, as recited in claim 1, wherein said electrochemical cells are DC-power generators, using hydrogen and carbon monoxide as fuel and oxygen gas and air as oxidizer.

11. Solid oxygen ion conducting electrolytes for electrochemical cells, as recited in claim 1, wherein said oxygen ion conducting electrolytes have attached electrodes, and at least one of said electrodes consists of at least one of the group consisting of copper, silver, gold, iron, cobalt, nickel, ruthenium, rhodium, palladium, osmium, iridium, platinum, chromium, manganese, molybdenum, tungsten, silicon, and carbon.

12. Solid oxygen ion conducting electrolytes for electrochemical cells, as recited in claim 1, wherein said oxygen ion conducting electrolytes have attached electrodes, and at least one of said electrodes consists of an electronically conducting complex oxide composed of elements, having the general formula ABO₃, where element A consists of at least one of the group of calcium, strontium, barium, yttrium, scandium, lanthanum, cerium, praseodymium, neodymium, samarium, gadolinium, ytterbium, and where element B consists of at least one of the group of iron, cobalt, nickel, chromium, manganese, copper, magnesium, aluminum, gallium, indium, titanium, zirconium, halnium, niobium, vanadium, tantalum, and zinc.

13. Solid oxygen ion conducting electrolytes for electrochemical cells, as recited in claim 1, wherein said oxygen ion conducting electrolytes have attached electrodes, and at least one of said electrodes consists of a mixture of a metal with its own oxide, selected from a group consisting of (Ru/RuO₂), (Rh/RhO), (Pd/PdO), (Os/OsO₂), (Cu/Cu₂O), (Co/CoO), (Ni/NiO), and (Cr/Cr₂O₃).

14. Solid oxygen ion conducting electrolytes for electrochemical cells, as recited in claim 1, including a reference electrode consisting of at least one compound of the group consisting of (Ru/RuO₂), (Rh/RhO), (PdpdO), (Os/OsO₂), (Cu/Cu₂O), (Ni/NiO), and (Cr/Cr₂O₃), said reference electrode, being disposed in an enclosure formed by the solid oxygen ion conducting electrolyte, and having contact means attached thereto and extending through the solid oxygen ion conducting electrolyte enclosure.

15. Solid oxygen ion conducting electrolytes for electrochemical cells, as recited in claim 1, wherein said electrochemical cells are primary and secondary batteries, having anodes and cathodes, said anodes comprising at least one element of the group consisting of lithium, potassium, sodium, magnesium, calcium, strontium, zinc, aluminum, cerium, titanium, zirconium, silicon, manganese, iron, cobalt, nickel, and carbon, and the cathodes consist of at least one of the group of platinum, palladium, iridium, gold, silver, copper, nickel, cobalt, iron, praseodymium oxide (Pr₆O₁₁), palladium oxide (PdO), copper oxides (Cu₂O, CuO), nickel oxide (NiO), cobalt oxide (CoO), iron oxides (Fe₃O₄, Fe₂O₃, FeO), zinc oxide (ZnO), indium oxide (In₂O₃), bismuth oxides (Bi₂O₃, BiO), antimony oxides (Sb₂O₃, SbO₂), and tin oxides (SnO, SnO₂).

16. Solid oxygen ion conducting electrolyte for electrochemical cells, as recited in claim 1, wherein said electrochemical cells are oxygen sensors for the control of the combustion process of internal combustion engines.

17. Solid oxygen ion conducting electrolyte for electrochemical cells, as recited in claim 1, wherein said electrochemical cells are oxygen sensors for the control of combustion processes in power plants for generating electrical energy.

18. Solid oxygen ion conducting electrolyte for electrochemical cells, as recited in claim 1, wherein said electrochemical cells are oxygen sensors for the control of combustion processes for heating purposes.

19. Solid oxygen ion conducting electrolyte for electrochemical cells, as recited in claim 1, wherein said electrochemical cells are oxygen sensors for the measurement of oxygen concentrations in molten metals.

20. Electrical heater elements made of oxygen ion conducting materials composed of host oxides and metal fluoride additives, where said host oxides are at least one of the group of calcium oxide (CaO), and magnesium oxide (MgO), and said metal fluorides additives are at least one of the group of lithium fluoride, sodium fluoride, potassium fluoride, magnesium fluoride, calcium fluoride, and strontium fluoride, and where said host oxide concentration in said heater elements lies in the range of 60.0 mol % to 99.9 mol %, and whereby said heater elements being in electrical contact with electronically conducting electrodes.
